(19) United States
(12) Patent Application Publication
(10) Pub. No.: US 2008/0243613 A1
(43) Pub. Date: Oct. 2, 2008

(54) Optimization of pay per click advertisements

(75) Inventors: James Luke Silvestri, Beverly, MA (US); Jose D. Saura, Kent, WA (US); Kevin Yin-Sin Seng, Seattle, WA (US)

Correspondence Address: MICROSOFT CORPORATION, ONE MICROSOFT WAY, REDMOND, WA, 98052, US

(73) Assignee: Microsoft Corporation, Redmond, WA (US)

(21) Appl. No.: 11/732,031

(22) Filed: Apr. 2, 2007

(51) Int. Cl. G06Q 30/00

(52) U.S. Cl. 705/14

(57) ABSTRACT

An advertising management service allows an advertiser to create an advertisement and associate keywords with the advertisement. The advertising management service submits the advertisement to multiple search engine advertising networks on behalf of the advertiser. Periodically, the advertising management service receives a performance indicator for the keywords from the search engine advertising networks. Using the performance indicator, the advertising management service identifies some of the keywords as low performing keywords. The advertising management service replaces the low performing keywords with new keywords on the multiple search engine advertising networks. The advertising management service may also periodically reallocate a budget for the advertisement among the multiple search engine advertising networks based on the performance indicator.

### BACKGROUND

Pay per click advertising permits advertisers to create online advertisements and to bid on keywords they believe are relevant to their target market. When a search query is received that includes the keywords, the advertisement is displayed along with relevant search results for the keywords. The on-screen position of the advertisement depends upon the maximum bid amount specified by the advertiser. Higher bids typically result in better placement of the advertisement. The advertiser only pays if a user clicks on the advertisement.

While pay per click advertising has become extremely popular, it remains difficult for an individual or small business to set up an advertising campaign. Writing content for an advertisement, selecting keywords, setting a budget, and bidding on terms can be a complicated, time consuming process that must be repeated for each search engine advertising network at which the advertisement is placed.

Once an advertising campaign has been created, an advertiser must often spend a considerable amount of time determining the keywords that are generating the most referrals from each search engine and replacing low performing keywords with new terms. This also can be a difficult and time-consuming process, especially if the advertisement is placed on multiple search engine advertising networks. Because the software tools for performing these functions are advertising network specific, advertisers are generally required to master multiple tools or to limit their advertising to only one search engine.

It is with respect to these considerations and others that the disclosure made herein is provided.

### SUMMARY

Technologies are described herein for optimizing online advertisements, such as pay per click advertisements. Through aspects presented herein, an advertiser can easily and quickly create an advertisement, keywords, and a budget, and have the advertisement submitted to multiple search engine advertising networks. Moreover, performance of the advertisement is optimized with little or no intervention required from the advertiser.

According to one aspect presented herein, an advertising management service is provided through which an advertiser can create an advertisement and specify keywords associated with the advertisement. The advertising management service submits the advertisement to multiple search engine advertising networks on behalf of the advertiser. Periodically, the advertising management service receives a performance indicator for the keywords from the search engine advertising networks. The performance indicator may be data indicating the number of conversions generated by each keyword, such as an electronic commerce (“e-commerce”) sale, or data indicating the number of web page visits generated by each keyword.

Using the performance indicator, the advertising management service identifies one or more of the keywords as low performing keywords. The advertising management service also generates new keywords. The new keywords may be synonyms of the keywords originally specified by the advertiser or other related terms. The advertising management service replaces the low performing keywords with the new keywords on the multiple search engine advertising networks. By periodically replacing poorly performing keywords in this manner, the advertising management service improves the performance of the keyword advertisement.

According to other aspects, the advertising management service also receives a budget when an advertisement is created. The budget is allocated among the multiple search engine advertising networks. Periodically, the advertising management service reallocates the budget among the multiple search engine advertising networks based on the performance indicator. In one implementation, a portion of the budget is allocated to each keyword. The advertising management service periodically reallocates the budget among the keywords based on the performance indicator. For instance, the portion of the budget for a highly performing keyword on one advertising network may be increased while the portion of the budget for a poorly performing keyword on another network may be reduced.

The above-described subject matter may also be implemented as a computer-controlled apparatus, a computer process, a computing system, or as an article of manufacture such as a computer-readable medium. These and various other features will be apparent from a reading of the following Detailed Description and a review of the associated drawings.

This Summary is provided to introduce a selection of concepts in a simplified form that are further described below in the Detailed Description. This Summary is not intended to identify key features or essential features of the claimed subject matter, nor is it intended that this Summary be used to limit the scope of the claimed subject matter. Furthermore, the claimed subject matter is not limited to implementations that solve any or all disadvantages noted in any part of this disclosure.

### BRIEF DESCRIPTION OF THE DRAWINGS

FIG. 1 is a network and software architecture diagram showing aspects of various software components utilized in one embodiment described herein;

FIGS. 2-5 are flow diagrams showing aspects of the operation of an advertising management service provided in one implementation described herein; and

FIG. 6 is a computer architecture diagram showing an illustrative hardware architecture suitable for implementing the computing systems described with reference to FIGS. 1-5.

### DETAILED DESCRIPTION

The following detailed description is directed to technologies for optimizing an online advertisement. As will be discussed in greater detail below, an advertising management service is provided herein that optimizes the performance of an online advertisement across multiple advertising networks. This allows an advertiser to more easily advertise on multiple search engine advertising networks and to maximize the return on their investment in such advertising.

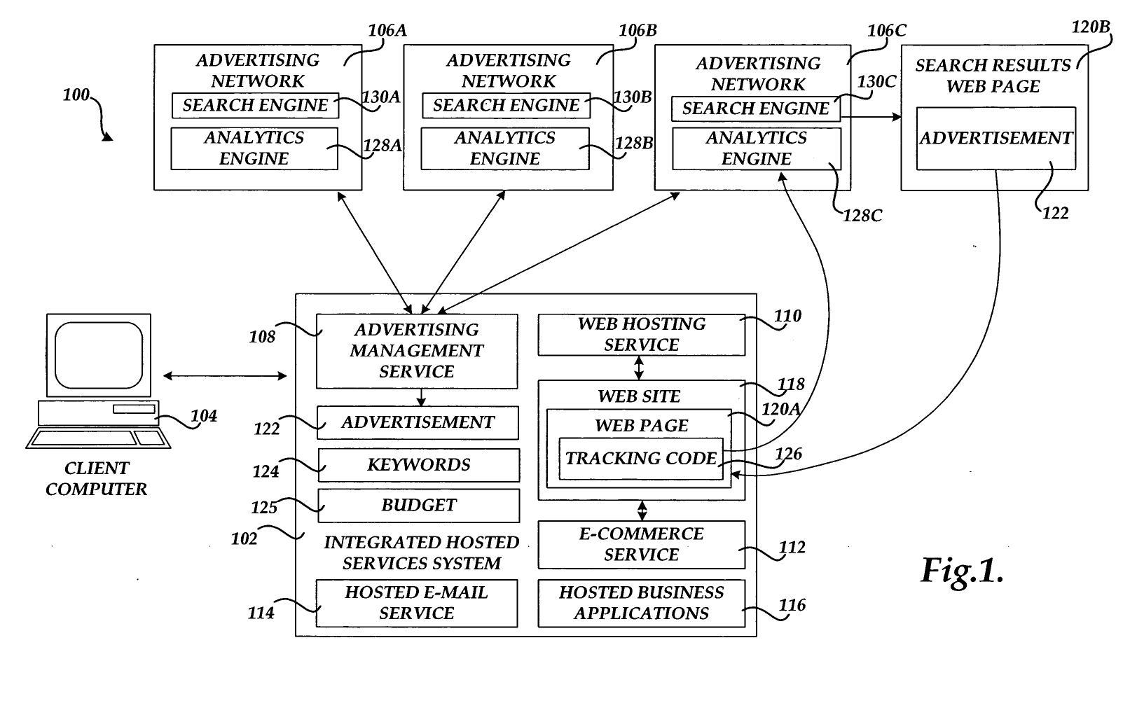

One type of online advertising that may be optimized utilizing the technologies described herein is pay per click advertising. Pay per click advertising permits advertisers to create online advertisements and to bid on keywords at a search engine that they believe are relevant to their target market. When a search query is received at the search engine that includes the keywords, the advertisement is displayed along with relevant search results for the keywords. The on-screen position of the advertisement depends upon the maximum bid amount specified by the advertiser. Higher bids typically result in better placement of the advertisement. The advertiser only pays if a user clicks on the advertisement. Through aspects presented herein, an advertiser can easily submit an advertisement to multiple search engine advertising networks and have the performance of the advertisement optimized in an automated fashion. Additional details regarding this process are provided below with respect to FIGS. 1-6.

While the subject matter described herein is presented in the general context of program modules that execute in conjunction with the execution of an operating system and application programs on a computer system, those skilled in the art will recognize that other implementations may be performed in combination with other types of program modules. Generally, program modules include routines, programs, components, data structures, and other types of structures that perform particular tasks or implement particular abstract data types. Moreover, those skilled in the art will appreciate that the subject matter described herein may be practiced with other computer system configurations, including hand-held devices, multiprocessor systems, microprocessor-based or programmable consumer electronics, minicomputers, mainframe computers, and the like.

In the following detailed description, references are made to the accompanying drawings that form a part hereof, and which are shown by way of illustration specific embodiments or examples. Referring now to the drawings, in which like numerals represent like elements through the several figures, aspects of technologies provided herein for optimizing an online advertisement will be described.

FIG. 1 is a network and software architecture diagram showing aspects of various systems and software components utilized in one embodiment presented herein. As shown in FIG. 1, aspects of the embodiments presented herein may be implemented within an integrated hosted services system 102. The integrated hosted services system 102 provides a number of hosted network services that provide integrated tools for a small business. For instance, the integrated hosted services system 102 may provide a web hosting service 110 that includes online tools for creating and hosting a web site 118 for a business. The web site 118 includes one or more web pages 120A. Each web page 120A may include tracking code 126 for providing data about the activities of visitors to the web page 120A to an analytics engine. The web hosting service 110 inserts the appropriate tracking code 126 into the web pages at the time the time it creates the web site 118. Additional details regarding this process will be provided below.

In one implementation, the integrated hosted services system 102 also includes a hosted e-commerce service 112. The hosted e-commerce service 112 supplies back-end functionality for providing an e-commerce marketplace, including shopping cart functionality, payment processing, order tracking, and other functions. The e-commerce service 112 may integrate with the functionality provided by the web hosting service 110 to allow a small business to easily create a web page 120A through which goods or services may be offered for sale.

Because the integrated hosted services system 102 hosts both the web hosting service 110 and the e-commerce service 112, detailed information may be obtained regarding the activities of visitors to the web site 118. For instance, detailed records may be kept regarding the number of visitors to the web site 118, the length of time spent by visitors at the web site 118, the number of pages viewed by visitors at the web site 118, and whether or not a conversion was made by visitors to the web site 118. A conversion occurs when a prospective customer takes the advertiser's desired action. For instance, a conversion may comprise an e-commerce sale or the submission of a form for requesting additional information. As will be described in greater detail below, the detailed statistics provided by the web hosting service 110 and the e-commerce service 112 may be utilized to optimize an online advertisement.

According to other aspects, the integrated hosted services system 102 may also provide other types of hosted network services. For instance, in one implementation, the integrated hosted services system 102 may also provide a hosted electronic mail (“e-mail”) service 114. The e-mail service 114 allows a business to host e-mail accounts for their domain at the integrated hosted services system 102. The integrated hosted services system 102 may also include other hosted business applications 116, such as a hosted calendar, hosted to-do lists, hosted collaboration services, and other types of hosted business applications. A client computer 104 may connect to the integrated hosted services system 102 using a web browser application program to access the functionality provided by the web hosting service 110, the hosted e-mail service 114, and, as described below, an advertising management service 108 that is also provided by the integrated hosted services system 102.

The advertising management service 108 provides functionality for allowing an advertiser to create and manage an online advertisement 122. In particular, the advertising management service 108 provides a web interface through which a user of the client computer 104 can create an advertisement 122. As will be described in greater detail below, the advertising management service 108 manages the process of submitting the advertisement 122 to multiple search engine advertising networks 106A-106C. The networks 106A-106C typically operate Internet search engines 130A-130C through which searches can be made of web sites and other content available on the Internet. In this manner, the advertisement 122 may be displayed on a search results web page 120B following such a search. If a user selects the advertisement 122, the user is redirected to a web site associated with the advertisement 122, such as the web site 118. As will be described in greater detail below, the advertising management service 108 also provides functionality for optimizing the performance of an advertisement 122 across multiple advertising networks 106A-106C. Additional detail regarding this functionality is provided below.

As described briefly above, the advertising management service 108 provides functionality for allowing an advertiser to create an online advertisement 122. The advertisement 122 includes text that should be displayed to a user along with a hyperlink that is activated when the advertisement 122 is selected within a web browser. For instance, a hyperlink directed to the web site 118 may be specified along with the advertisement 122. In this manner, selection of the advertisement 122 within a web browser program will cause a potential customer to be redirected to the web site 118.

The advertising management service 108 also allows an advertiser to specify one or more keywords 124 that are associated with the advertisement 122. The keywords 124 are utilized by the search engines 130A-130C to determine when the advertisement 122 should be displayed. For instance, if the advertisement 122 is for professional accounting services, the keywords 124 may include “accountant,” “taxes,” “IRS,” or other similar words. In this regard, the advertising management service 108 may provide functionality for assisting a user with the identification and selection of the keywords 124.

When a search is made for one of the keywords 124 or related terms at one of the search engines 130A-130C, the advertisement 122 may be displayed along with other search results in a search results web page 120B. If a user selects the advertisement 122, the user will be redirected to the web site 118. When the web page 120A is displayed, the tracking code 126 embedded therein is executed. The tracking code 126 provides information to an analytics engine 128C at the advertising network 106C that supplied the advertisement 122 regarding the referring site. Where a search engine is the referring site, this data identifies the particular keyword that was utilized in the search that generated the referral. In this manner, the analytics engine 128C can identify the keywords that are generating the most traffic to the web site 118. It should be appreciated that an advertising network, including a search engine and analytics engine, may be hosted at or closely affiliated with the integrated hosted services system 102. In this manner, data regarding the performance of the keywords 124 may be provided to the advertising management service 108.

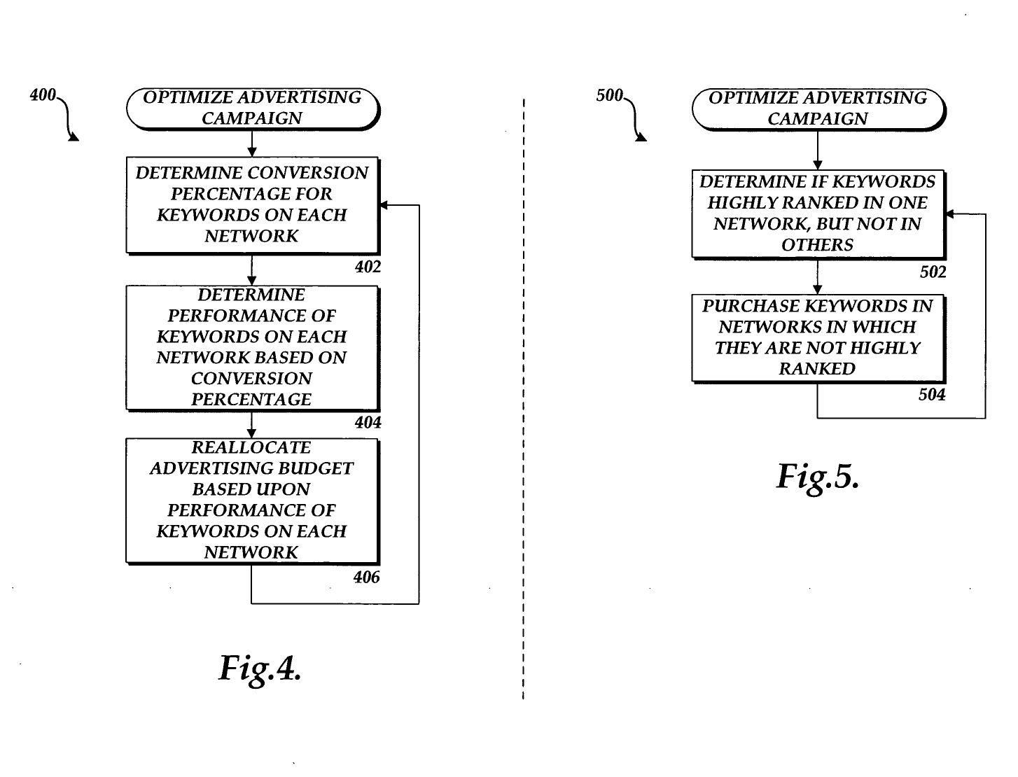

When an advertisement 122 is created at the advertising management service 108, a budget 125 may also be specified. The budget 125 may specify a maximum amount to be expended on the advertisement 125. The budget 125 may also specify a maximum bid to be placed on each of the keywords 125. As will be discussed in greater detail below, the advertising management service 108 provides functionality for reallocating the specified budget 125 to maximize the performance of the keywords 124. This functionality is described in greater detail below with respect to FIGS. 4 and 5.

According to other implementations, the advertising management service 108 provides functionality for replacing low performing keywords at the advertising networks 106A-106C with new keywords generated by the advertising management service 108. In this regard, the budget 125 may also specify a percentage of the total budget that may be utilized by the advertising management service 108 for keyword advertising using keywords generated by the advertising management service 108. Additional details regarding this functionality are provided below with respect to FIG. 3.

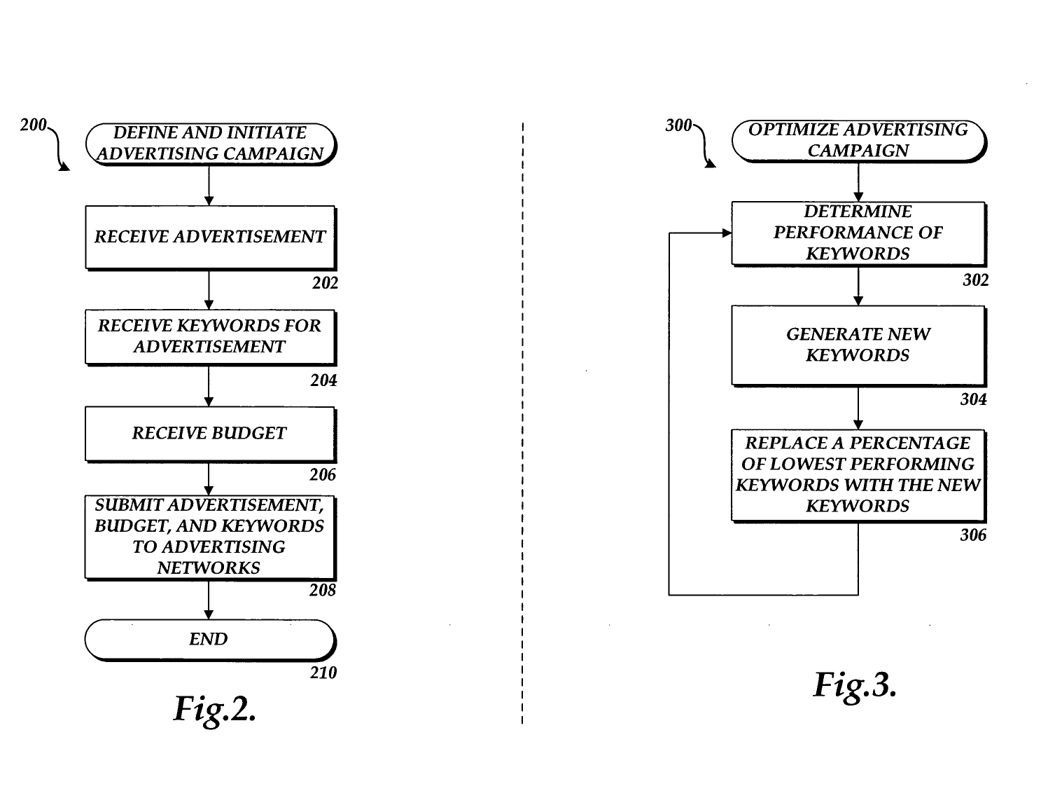

Referring now to FIG. 2, additional details will be provided regarding the operation of the advertising management service 108. In particular, FIG. 2 is a flow diagram showing a routine 200 that illustrates the operation of the advertising management service 108 for creating an advertisement and submitting the advertisement to multiple advertising networks 106A-106C. It should be appreciated that the logical operations described herein with respect to FIGS. 2-5 are implemented (1) as a sequence of computer implemented acts or program modules running on a computing system and/or (2) as interconnected machine logic circuits or circuit modules within the computing system. The implementation is a matter of choice dependent on the performance requirements of the computing system. Accordingly, the logical operations described herein are referred to variously as operations, structural devices, acts, or modules. These operations, structural devices, acts and modules may be implemented in software, in firmware, in special purpose digital logic, and any combination thereof. It should also be appreciated that more or fewer operations may be performed than shown in FIG. 2-5 and described herein. These operations may also be performed in a different order than those described herein with respect to FIGS. 2-5.

The routine 200 begins at operation 202, where the advertising management service 108 receives the advertisement 122 from a user. As discussed above, the advertising management service 108 provides a web-accessible interface for creating such an advertisement. A user may access the interface through the use of a client computer 104 executing a web browser application program. During the creation of the advertisement 122, the advertising management service 108 also receives one or more keywords from the user at operation 204. As discussed above, the keywords are utilized by the search engines 130A-130C to display the advertisement 122 in response to relevant queries received at the search engines 130A-130C, respectively. The advertising management service 108 may provide facilities for suggesting keywords appropriate for text included in the advertisement 122. The advertising management service 108 may also provide a facility for selecting which of the advertising networks 106A-106C the advertisement 122 should be submitted to.

From operation 204, the routine 200 continues to operation 206, where the budget 125 is also received from the user. As discussed above, the budget 206 may specify a maximum amount to be expended on the advertisement 122, a maximum bid to be placed on each of the keywords 124, and a percentage of the total budget that may be utilized by the advertising management service 108 for keyword advertising using keywords generated in an automated fashion by the advertising management service 108. Reallocation of the budget to different advertising networks 106A-106C and among the various keywords 124 will be described in greater detail below with respect to FIGS. 2-5.

From operation 206, the routine 200 continues to operation 208, where the advertising management service 108 submits the advertisement 122, the keywords 124, and the budget 125 to the desired advertising networks 106A-106C. The advertising networks 106A-106C may expose a web service application programming interface (“API”) for receiving this data. Once the advertisement 122, keywords 124, and budget 125 have been submitted to the advertising networks 106A-106C, the advertisement 122 may be displayed within search results web pages in the manner described above. From operation 208, the routine 200 continues to operation 210, where it ends.

Turning now to FIG. 3, an illustrative routine 300 will be described that illustrates one aspect of the operation of the advertising management service 108 for optimizing the performance of the advertisement 122 on the advertising networks 106A-106C. The routine 300 begins at operation 302 where the advertising management service 108 determines the performance of the keywords 124. The performance of the keywords may be determined based on performance indicators received from the analytics engines 128A-128C executing at the advertising networks 106A-106C. For instance, the analytics engines 128A-128C may provide data regarding the number of conversions generated by each keyword, the number of web page visits generated by each keyword, and other types of performance data. The advertising management service 108 may also obtain this data directly from the web hosting service 110 and the e-commerce service 112.

From operation 302, the routine 300 continues to operation 304, where the advertising management service 108 generates new keywords. The new keywords may be synonyms, similar words, or terms that are otherwise related to the keywords 124 originally submitted by the advertiser. Once the new keywords have been generated, the routine 300 continues to operation 306, where the advertising management service 108 replaces some of the lowest performing keywords with the newly generated keywords on the advertising networks 106A-106B. In this manner, low performing keywords are replaced with new keywords likely to improve performance. By performing this process periodically, the performance of the keywords may be improved and, consequently, the performance of the advertisement 122 may be improved.

As described above, the budget 125 may specify a percentage that may be utilized by the advertising management service 108 for keyword advertising using keywords generated in an automated fashion by the advertising management service 108. If such a limitation has been specified in the budget 125, the advertising management service 108 will only replace keywords at operation 306 up to this limitation. In particular, instructions may be provided to the advertising networks 106A-106B regarding the limited amount that should be spent on advertising for these keywords. In this manner, an advertiser can limit the percentage of the total budget 125 spent on keywords generated by the advertising management service 108. From operation 304, the routine 300 returns to operation 302, described above.

Referring now to FIG. 4, an illustrative routine 400 will be described that illustrates another aspect of the operation of the advertising management service 108 for optimizing the performance of the advertisement 122 on the advertising networks 106A-106C. The routine 400 begins at operation 402, where the advertising management service 108 determines the conversion percentage for each of the keywords 124. As discussed above, the e-commerce service 112 and the analytics engines 128A-128C may provide data regarding the number of conversions generated by each keyword.

Once the conversion percentage has been determined by the advertising management service 108, the routine 400 continues from operation 402 to operation 404. At operation 404, the performance of each of the keywords 124 is determined based on their relative conversion percentage. The performance of each of the keywords 124 may be based upon other factors, such as the number of web pages visits generated or other factors.

From operation 404, the routine 400 continues to operation 406, where the advertising management service 108 reallocates the budget 125 among the advertising networks 106A-106C depending on the performance of the keywords 124. For instance, if one of the advertising networks 106A-106C is generating a higher percentage of conversions, a greater portion of the budget 125 may be allocated to that network. By periodically evaluating the performance of the advertisement 122 on each of the advertising networks 106A-106C and reallocating the budget 125 accordingly, the performance of the advertisement 122 across all of the networks 106 may be improved.

Turning now to FIG. 5, an illustrative routine 500 will be described that illustrates yet another aspect of the operation of the advertising management service 108 for optimizing the performance of the advertisement 122 on the advertising networks 106A-106C. The routine 500 begins at operation 502, where the advertising management service 108 determines if any of the keywords 124 are highly ranked in one of the advertising networks 106A-106B, but not in others. If so, the routine 500 continues to operation 504 where the advertising management service 108 purchases these keywords in the networks 106 where they are not highly ranked. In a similar manner, if a keyword is identified that has not been purchased on one network 106 and is generating a large number of referrals from that network, but is not generating referrals on the other networks 106, the advertising management service 108 may reallocate the budget 125 to purchase the keyword on the other advertising networks 106A-106C.

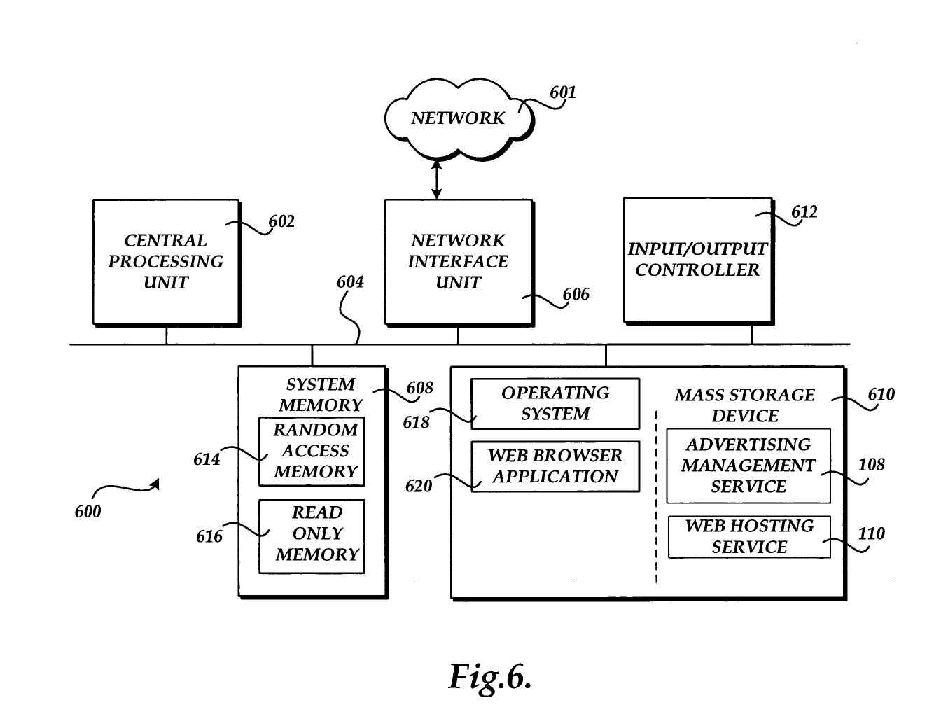

Referring now to FIG. 6, an illustrative computer architecture for a computer 600 capable of executing the software components described above with respect to FIGS. 1-5 will be discussed. The computer architecture shown in FIG. 6 illustrates a conventional desktop, laptop computer, or server computer, and may be utilized to embody the client computer 104, computers utilized within the advertising networks 106A-106C, or computers utilized within the integrated hosted services system 102.

The computer architecture shown in FIG. 6 includes one or more central processing units 602 (“CPU”), a system memory 608, including a random access memory 614 (“RAM”) and a read-only memory (“ROM”) 616, and a system bus 604 that couples the memory to the CPU 602. A basic input/output system containing the basic routines that help to transfer information between elements within the computer 600, such as during startup, is stored in the ROM 616. The computer 600 further includes a mass storage device 610 for storing an operating system 618, application programs, and other program modules, which will be described in greater detail below.

The mass storage device 610 is connected to the CPU 602 through a mass storage controller (not shown) connected to the bus 604. The mass storage device 610 and its associated computer-readable media provide non-volatile storage for the computer 600. Although the description of computer-readable media contained herein refers to a mass storage device, such as a hard disk or CD-ROM drive, it should be appreciated by those skilled in the art that computer-readable media can be any available media that can be accessed by the computer 600.

By way of example, and not limitation, computer-readable media may include volatile and non-volatile, removable and non-removable media implemented in any method or technology for storage of information such as computer-readable instructions, data structures, program modules or other data. For example, computer-readable media includes, but is not limited to, RAM, ROM, EPROM, EEPROM, flash memory or other solid state memory technology, CD-ROM, digital versatile disks (“DVD”), HD-DVD, BLU-RAY, or other optical storage, magnetic cassettes, magnetic tape, magnetic disk storage or other magnetic storage devices, or any other medium which can be used to store the desired information and which can be accessed by the computer 600.

According to various embodiments, the computer 600 may operate in a networked environment using logical connections to remote computers through a network such as the network 601. The computer 600 may connect to the network 601 through a network interface unit 606 connected to the bus 604. It should be appreciated that the network interface unit 606 may also be utilized to connect to other types of networks and remote computer systems. The computer 600 may also include an input/output controller 612 for receiving and processing input from a number of other devices, including a keyboard, mouse, or electronic stylus (not shown in FIG. 6). Similarly, an input/output controller may provide output to a display screen, a printer, or other type of output device (also not shown in FIG. 6).

As mentioned briefly above, a number of program modules and data files may be stored in the mass storage device 610 and RAM 614 of the computer 600, including an operating system suitable for controlling the operation of a networked desktop, laptop, or server computer. The mass storage device 610 and RAM 614 may also store one or more program modules. In particular, the mass storage device 610 and the RAM 614 may store a web browser application 620, the advertising management service 108, and the web hosting service 110, each of which has been described above with reference to FIGS. 1-5. Other program modules may also be stored in the mass storage device 610 and utilized by the computer 600.

Based on the foregoing, it should be appreciated that technologies for optimizing an online advertisement are provided herein. It should also be appreciated that the advertising management service 108 may perform some of the optimizations described herein but not others. The advertising management service 108 may also perform other optimizations not described herein. Additionally, although the subject matter presented herein has been described in language specific to computer structural features, methodological acts, and computer readable media, it is to be understood that the invention defined in the appended claims is not necessarily limited to the specific features, acts, or media described herein. Rather, the specific features, acts and mediums are disclosed as example forms of implementing the claims.

The subject matter described above is provided by way of illustration only and should not be construed as limiting. Various modifications and changes may be made to the subject matter described herein without following the example embodiments and applications illustrated and described, and without departing from the true spirit and scope of the present invention, which is set forth in the following claims.

What is claimed is:

1. A method for optimizing the performance of an online advertisement, the method comprising:
submitting an advertisement to a plurality of advertising networks, the advertisement having one or more associated keywords;
receiving a performance indicator for the keywords;
identifying one or more of the keywords as low performing keywords using the performance indicator;
generating one or more new keywords; and
replacing the low performing keywords with the new keywords on the plurality of advertising networks.

2. The method of claim 1, wherein the performance indicator comprises data indicating a number of conversions generated by each keyword.

3. The method of claim 2, wherein a conversion comprises an electronic commerce sale.

4. The method of claim 1, wherein the performance indicator comprises data indicating a number of web page visits generated by each keyword.

5. The method of claim 1, further comprising:
receiving data identifying a budget for advertising with the keywords, the budget specifying a portion of the budget to be utilized for advertising with the new keywords; and
providing instructions to the plurality of advertising networks to limit a cost for advertising with the new keywords to the portion.

6. The method of claim 1, further comprising receiving data identifying a maximum percentage of the keywords that should be replaced with the new keywords, and wherein replacing the low performing keywords with the new keywords on the plurality of advertising networks comprises replacing a number of the low performing keywords with the new keywords no greater than the maximum percentage of the keywords.

7. The method of claim 1, wherein the performance indicator is received from the plurality of advertising networks.

8. A computer-readable media having computer-executable instructions stored thereon which, when executed by a computer, cause the computer to perform the method of claim 1.

9. A method for optimizing the performance of an online advertisement, the method comprising:
submitting an advertisement to a plurality of advertising networks;
receiving data specifying a budget for the advertisement;
allocating the budget among the plurality of advertising networks;
receiving a performance indicator for the advertisement; and
reallocating the budget among the plurality of advertising networks based on the performance indicator.

10. The method of claim 9, further comprising:
associating one or more keywords with the advertisement;
submitting the keywords to the plurality of advertising networks;
allocating a portion of the budget to each of the keywords; and
reallocating the budget among the keywords periodically based on the performance indicator.

11. The method of claim 9, wherein the performance indicator comprises data indicating a number of conversions generated by each keyword.

12. The method of claim 11, wherein a conversion comprises an electronic commerce sale.

13. The method of claim 9, wherein the performance indicator comprises data indicating a number of web page visits generated by each keyword.

14. The method of claim 9, wherein the performance indicator is received from the plurality of advertising networks.

15. A computer-readable media having computer-executable instructions stored thereon which, when executed by a computer, cause the computer to perform the method of claim 9.

16. A method for optimizing the performance of an online advertisement, the method comprising:
submitting an advertisement to a plurality of advertising networks, the advertisement having one or more associated keywords and an associated budget;
allocating the budget among the plurality of advertising networks;
receiving a performance indicator for the advertisement;
identifying one or more of the keywords as low performing keywords based on the performance indicator;
replacing the low performing keywords with one or more new keywords; and
reallocating the budget among the plurality of advertising network based on the performance indicator.

17. The method of claim 16, wherein the budget specifies a portion of the budget to be utilized for advertising with the new keywords, and wherein the method further comprises providing instructions to the plurality of advertising networks to limit a cost for advertising with the new keywords to the portion.

18. The method of claim 16, further comprising receiving data identifying a maximum percentage of the keywords that should be replaced with the new keywords, and wherein replacing the low performing keywords with the new keywords on the plurality of advertising networks comprises replacing a number of the low performing keywords with the new keywords no greater than the maximum percentage of the keywords.

19. The method of claim 16, further comprising:
allocating a portion of the budget to each of the keywords; and
reallocating the budget among the keywords periodically based on the performance indicator.

20. A computer-readable media having computer-executable instructions stored thereon which, when executed by a computer, cause the computer to perform the method of claim 16.
